(19) United States
(12) Patent Application Publication
(10) Pub. No.: US 2026/0079517 A1
(43) Pub. Date: Mar. 19, 2026

(54) LOW-DROPOUT (LDO) REGULATOR USING POLE ADAPTIVE CONTROL TO IMPROVE STABILITY

(71) Applicant: QUALCOMM Incorporated, San Diego, CA (US)

(72) Inventors: Emanuele LOPELLI, Laguna Niguel, CA (US); Payam LAJEVARDI, Sunnyvale, CA (US); Kamyar KHOSRAVIANI, Irvine, CA (US); Roger BROCKENBROUGH, Los Gatos, CA (US)

(21) Appl. No.: 18/889,010

(22) Filed: Sep. 18, 2024

(51) Int. Cl. G05F 1/575

(52) U.S. Cl. CPC G05F 1/575

(57) ABSTRACT

Certain aspects of the present disclosure generally relate to electronic circuits and, more particularly, to a low-dropout (LDO) regulator. The LDO regulator generally includes: an error amplifier; an output transistor coupled to an output of the LDO regulator and having a gate coupled to an output of the error amplifier, at least one first tail transistor coupled to the error amplifier; and a control circuit having an input coupled to the output transistor and at least one output coupled to at least one gate of the at least one first tail transistor.

### TECHNICAL FIELD

Certain aspects of the present disclosure generally relate to electronic circuits and, more particularly, to a low-dropout (LDO) regulator.

### BACKGROUND

A voltage regulator may provide a constant direct current (DC) output voltage regardless of changes in load current or input voltage. Voltage regulators may be classified as linear regulators or switching regulators. While linear regulators tend to be relatively compact, many applications may benefit from the increased efficiency of a switching regulator. A linear regulator may be implemented by a low-dropout (LDO) regulator, for example.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide the advantages described herein.

Certain aspects of the present disclosure are directed towards a low-dropout (LDO) regulator. The LDO regulator generally includes: an error amplifier; an output transistor coupled to an output of the LDO regulator and having a gate coupled to an output of the error amplifier; at least one first tail transistor coupled to the error amplifier; and a control circuit having an input coupled to the output transistor and at least one output coupled to at least one gate of the at least one first tail transistor.

Certain aspects of the present disclosure are directed towards a method for voltage regulation. The method generally includes: sensing a load current of an LDO regulator including an error amplifier; generating a control voltage based on the load current; and generating a tail current to bias the error amplifier based on the control voltage.

Certain aspects of the present disclosure are directed towards an electronic device. The electronic device generally includes: one or more processors and a power management integrated circuit coupled to the one or more processors and including an LDO regulator. The LDO regulator generally includes: an error amplifier; an output transistor coupled to an output of the LDO regulator and having a gate coupled to an output of the error amplifier; at least one first tail transistor coupled to the error amplifier; and a control circuit having an input coupled to the output transistor and at least one output coupled to at least one gate of the at least one first tail transistor.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of an example device that includes a power supply system with at least one low-dropout (LDO) regulator, in which aspects of the present disclosure may be practiced.

FIG. 2 illustrates an example LDO regulator.

FIG. 3A illustrates graphs showing the impact of decreased load current on poles of an LDO regulator with extra margin implemented using a compensation capacitive element.

FIG. 3B illustrates graphs showing the impact of decreased load current on poles of an LDO regulator with extra margin implemented using a leaker current (Ileak).

FIG. 4 illustrates a graph showing the impact of decreased load current on poles of an LDO regulator, in accordance with certain aspects of the present disclosure.

FIG. 5 illustrates an example LDO regulator, in accordance with certain aspects of the present disclosure.

FIG. 6 illustrates an example LDO regulator implemented with a variable tail current source circuit implemented with digital circuitry, in accordance with certain aspects of the present disclosure.

FIG. 7 illustrates an n-type metal-oxide-semiconductor (NMOS) LDO regulator, in accordance with certain aspects of the present disclosure.

FIG. 8 is a flow diagram illustrating example operations for voltage regulation, in accordance with certain aspects of the present disclosure.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Certain aspects of the present disclosure are directed toward a low-dropout (LDO) regulator. The LDO regulator may be implemented with a control and bias circuit to generate a tail current for an error amplifier of the LDO regulator. The tail current may be adjusted based on the load current of the LDO regulator so that frequencies of poles of the LDO regulator change at the same rate. In this manner, the poles (e.g., a main first pole and a second pole) of the LDO regulator may remain at the same distance in frequency (e.g., or at least closer to the same distance with respect to some conventional implementations) so that the phase margin of the LDO regulator is not degraded (e.g., or experiences reduced degradation) across the load current range. Thus, some aspects use a main pole adaptive control scheme for the LDO regulator in such a way that the main pole moves in synch with the load current, keeping the distance in frequency between the main pole and the second pole constant with respect to the load current

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### An Example Device

It should be understood that aspects of the present disclosure may be used in a variety of applications. Although the present disclosure is not limited in this respect, the circuits disclosed herein may be used in any of various suitable apparatuses, such as in the power supply, battery charging circuit, or power management circuit of a communication system, a video codec, audio equipment such as music players and microphones, a television, camera equipment, and test equipment such as an oscilloscope. Communication systems intended to be included within the scope of the present disclosure include, by way of example only, cellular radiotelephone communication systems, satellite communication systems, two-way radio communication systems, one-way pagers, two-way pagers, personal communication systems (PCS), personal digital assistants (PDAs), and the like.

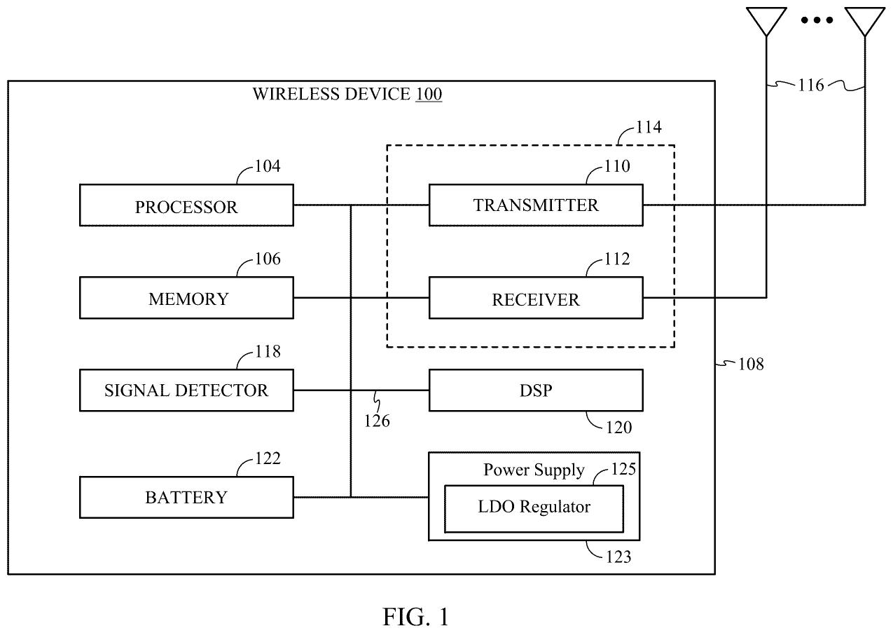

FIG. 1 illustrates an example device 100 in which aspects of the present disclosure may be implemented. The device 100 may be a battery-operated device such as a cellular phone, a PDA, a handheld device, a wireless device, a laptop computer, a tablet, a smartphone, an Internet of things (IoT) device, a wearable device, a virtual reality (VR) or augmented reality (AR) device, etc.

The device 100 may include a processor 104 that controls operation of the device 100. The processor 104 may also be referred to as a central processing unit (CPU). Memory 106, which may include both read-only memory (ROM) and random access memory (RAM), provides instructions and data to the processor 104. A portion of the memory 106 may also include non-volatile random access memory (NVRAM). The processor 104 typically performs logical and arithmetic operations based on program instructions stored within the memory 106.

In certain aspects, the device 100 may also include a housing 108 that may include a transmitter 110 and a receiver 112 to allow transmission and reception of data between the device 100 and a remote location. For certain aspects, the transmitter 110 and receiver 112 may be combined into a transceiver 114. One or more antennas 116 may be attached or otherwise coupled to the housing 108 and electrically connected to the transceiver 114. The device 100 may also include (not shown) multiple transmitters, multiple receivers, and/or multiple transceivers.

The device 100 may also include a signal detector 118 that may be used in an effort to detect and quantify the level of signals received by the transceiver 114. The signal detector 118 may detect such signal parameters as total energy, energy per subcarrier per symbol, and power spectral density, among others. The device 100 may also include a digital signal processor (DSP) 120 for use in processing signals.

The device 100 may further include a battery 122, which may be used to power the various components of the device 100 (e.g., when the device is disconnected from an external power source). The device 100 may also include a power supply system 123 for managing the power from the battery (or from one or more power ports for receiving external power) to the various components of the device 100. At least a portion of the power supply system 123 may be implemented in one or more power management integrated circuits (power management ICs or PMICs) The power supply system 123 may perform a variety of functions for the device 100 such as DC-to-DC conversion, battery charging, power-source selection, voltage scaling, power sequencing, etc. For example, the power supply system 123 may include one or more power supply circuits, which may include an LDO regulator 125. The LDO regulator may be implemented with control and bias circuitry that improves phase margin over some conventional implementations, as described in more detail herein.

The various components of the device 100 may be coupled together by a bus system 126, which may include a power bus, a control signal bus, and/or a status signal bus in addition to a data bus. Additionally or alternatively, various combinations of the components of the device 100 may be coupled together by one or more other suitable techniques.

### Example Techniques for Phase Margin Improvement

Low-dropout (LDO) regulators may be modeled as two-pole systems with one pole (p1) at an output of an error amplifier of the LDO regulator and one pole (p2) at the LDO regulator output. The frequencies of the poles impact the phase margin of the LDO regulator. For example, the closer the frequencies of the poles, the poorer the phase margin of the LDO regulator. Some aspects of the present disclosure are directed toward an LDO with improved phase margin.

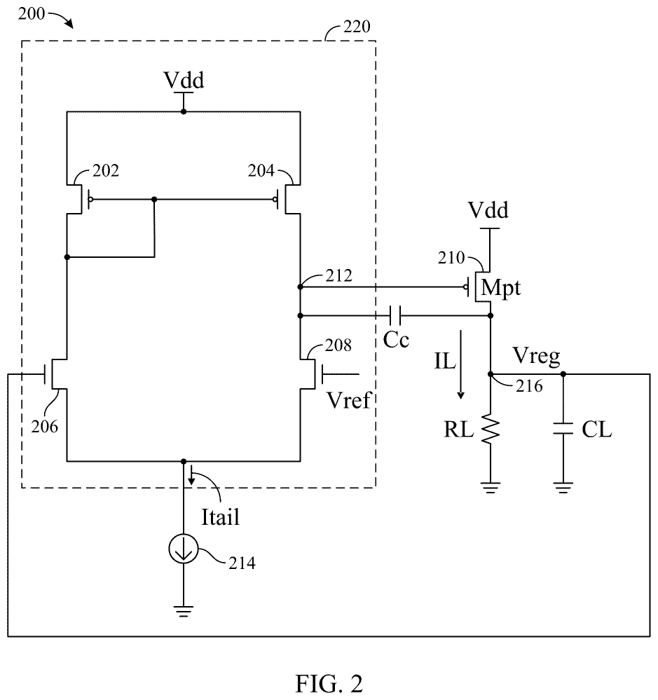

FIG. 2 illustrates an LDO regulator 200. The LDO regulator may include an error amplifier 220 including a p-type metal-oxide-semiconductor (PMOS) transistor 202 and a PMOS transistor 204 having sources coupled to a voltage rail (Vdd). A gate of transistor 202 may be coupled to a drain of transistor 202 and a drain of an n-type metal-oxide-semiconductor (NMOS) transistor 206. The drain of transistor 204 may be coupled to a drain of NMOS transistor 208, as shown. The gate of the transistor 208 may receive a reference voltage (Vref). The sources of transistors 206, 208 may be coupled to a tail current source 214, where the current source 214 sinks a tail current (e.g., labeled “Itail”) from the sources of transistors 206, 208 to bias the error amplifier 220. As shown, the output 212 of the error amplifier 220 may be coupled to a gate of a PMOS transistor 210 (e.g., labeled “Mpt”), where a source of transistor 210 is coupled to Vdd and a drain of transistor 210 is coupled to an output 216 of the LDO regulator 200 provided a regulated voltage (Vreg). In some cases, a compensation capacitive element (labeled “Cc” providing Miller-type compensation) may be coupled between the outputs 212, 216. A load resistive element (labeled “RL”) and a load capacitive element (“CL”) may be coupled to the output 216. A feedback path may be coupled between the output 216 and the gate of transistor 206 as shown. In some cases, each of the transistors 202, 204, 206, 208 of the error amplifier 220 may be referred to as an “amplification transistor.”

Dominant pole p1 at the output 212 may be calculated per equation:

$$p 1 = \frac{1}{g {m}_{Mpt} \times R L \times C c \times {rds}_{M p} // {rds}_{M n}}$$

where gm_{Mpt} is the transconductance of transistor 210, rds_{Mp} is the drain-to-source resistance of transistor 204, and rds_{Mn} is the drain-to-source resistance of transistor 208. A pole (p2) at the output 216 may be calculated per equation:

$$p 2 = \frac{1}{{R}_{L} \times {C}_{L}}$$

RL may be proportional to the inverse of a load current IL per equation:

$$R L ∝ \frac{1}{IL}$$

Moreover, the product of gm_{Mpt} and RL may be proportional to the inverse of the square root of IL per equation:

$$g {m}_{Mpt} \times R L ∝ \frac{1}{\sqrt{IL}}$$

Thus, the pole p2 decreases proportionally to IL, and the pole p1 decreases proportionally to \sqrt{IL}. At sufficiently low load currents, the stability of the LDO regulator may be affected, effectively reducing the load current range. Since pole p1 decreases proportionally to the square root of IL and pole p2 decreases proportionally to IL, p1 and p2 become closer in frequency as IL decreases, degrading the phase margin of the LDO regulator. In some cases, a bigger compensation capacitive element Cc may be used to improve phase margin. However, using a bigger Cc increases area consumption and may result in degraded unity gain bandwidth (UGB) and power supply rejection ratio (PSRR) at higher load currents.

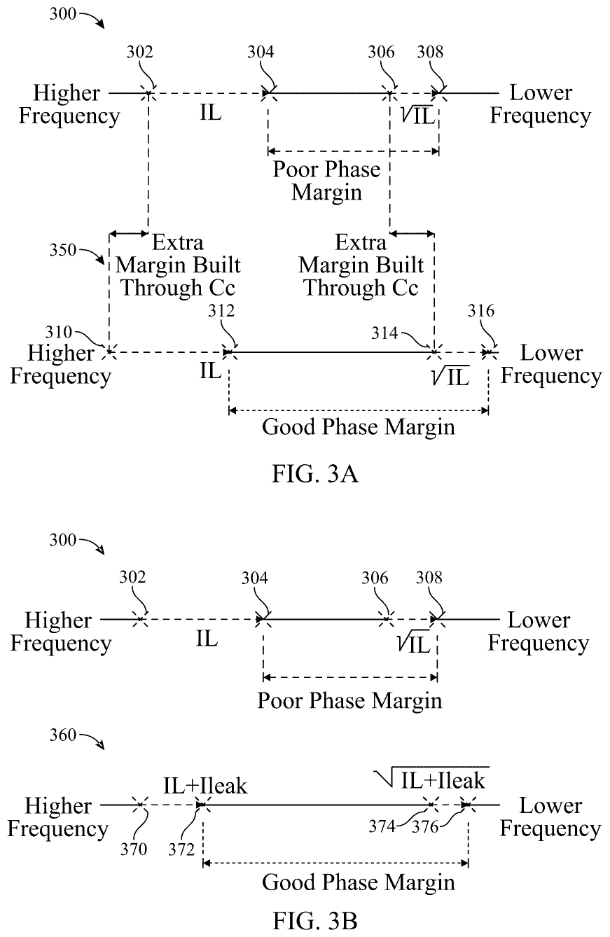

FIG. 3A illustrates graphs 300, 350 showing the impact of decreased IL on p1 and p2 and extra margin implemented using a Cc. Graph 300 shows the impact of decreased IL on p1 and p2 using a first capacitance for Cc and graph 350 shows the impact of decreased IL on p1 and p2 using a second capacitance for Cc greater than the first capacitance. As shown in graph 300, p2 may be at an initial frequency 302 and p1 may be at an initial frequency 306. Once IL decreases, p2 may decrease to frequency 304 and p1 may decrease to frequency 308. As shown, p1 decreases by a frequency difference that is less than p2, causing p1 and p2 to become closer in frequency and degrading phase margin. As shown in graph 350, by using a greater capacitance for Cc, the initial frequency 310 of p2 may be moved to a higher frequency and the initial frequency 314 of p1 may be moved to a lower frequency. Thus, even after IL decreases and p1 and p2 decrease to frequencies 312, 316, respectively, there is a higher phase margin as compared to using a lower capacitance for Cc.

In some cases, a leaker current may be used to set a lower limit on how low the IL can be, preventing p1 and p2 from becoming too close in frequency and limiting how much phase margin is degraded. However, using a leaker current may increase the LDO regulator's current consumption.

FIG. 3B illustrates graphs 300, 360 showing the impact of decreased IL on p1 and p2 and extra margin implemented using a leaker current (Ileak). Graph 300 shows the impact of decreased IL on p1 and p2 without using a leaker current and graph 350 shows the impact of decreased IL on p1 and p2 using a leaker current. As shown in graph 350, with decreased IL, p2 decreases from frequency 370 to frequency 372 and p1 decreases from frequency 374 to frequency 376, and the change in p1 and p2 is limited by the leaker current so that the phase margin does not degrade below a lower limit.

Some aspects of the present disclosure are directed towards an LDO regulator where p1 and p2 move to lower frequencies linearly as IL decreases. Thus, the distance in frequency between p1 and p2 may remain the same regardless of changes in IL.

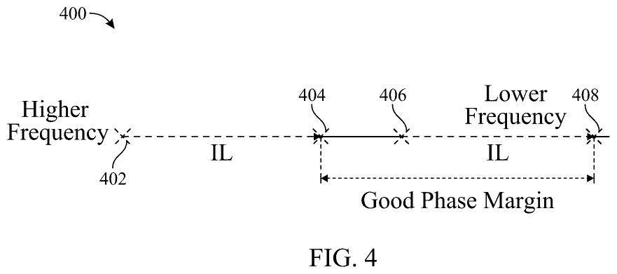

FIG. 4 illustrates a graph 400 showing the impact of decreased IL on p1 and p2, in accordance with certain aspects of the present disclosure. As shown, with decreased IL, p1 and p2 may decrease from frequencies 402, 406 to frequencies 404, 408 by the same frequency difference. Thus, p1 and p2 may not become closer together in frequency, and phase margin may not degrade with changes in IL.

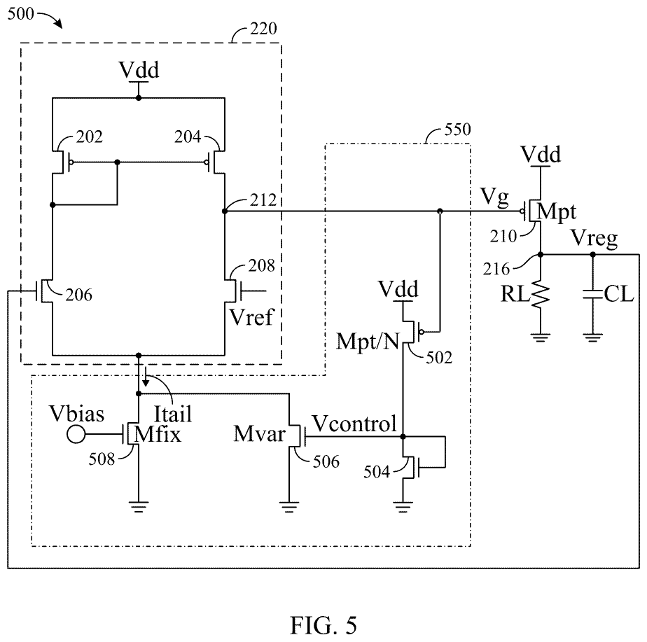

FIG. 5 illustrates an LDO regulator 500, in accordance with certain aspects of the present disclosure. The LDO regulator 500 may include a variable tail current source circuit 550 for the error amplifier 220, where the tail current of the error amplifier 220 is adjusted based on changes in IL so that p1 and p2 change linearly with IL. As shown, the circuit 550 includes a PMOS transistor 502 having a source coupled to Vdd and a drain coupled to a drain of a diode-connected NMOS transistor 504. The source of transistor 504 may be coupled to a reference potential node (e.g., electric ground). The drain of transistor 504 may be coupled to a gate of transistor 506 (e.g., labeled “Mvar”), acting as a variable current source. The transistor 506 may have a source coupled to the reference potential node (e.g., electric ground) and a drain coupled to the drains of transistors 206, 208. An NMOS transistor 508 may also have a source coupled to the reference potential node (e.g., electric ground) and a drain coupled to the drains of transistors 206, 208. The gate of transistor 508 may receive a bias voltage (Vbias) such that transistor 508 acts as a fixed current source. The transistors 506, 508 may form a tail current source for the error amplifier 220, such as the tail current source 214 described with respect to FIG. 2. The transistors 502, 504 form a control circuit to control the tail current of the error amplifier 220. In some cases, the tail current source formed by transistors 506, 508 may be considered to be part of the error amplifier 220.

As IL increase, the gate voltage (labeled “Vg”) of transistor 210 decreases to supply increased current from Vdd to the output 216. The decreased gate voltage of transistor 210 is also provided to the gate of transistor 502, increasing the current supplied from Vdd by the transistor 502 to the diode-connected transistor 504. The current from the transistor 502 may be converted to a control voltage (Vcontrol) and provided to a gate of transistor 506 to sink a current from the drains of the transistors 206, 208. Thus, as IL increases, the amount of current sunk from the drains of the transistors 206, 208 increases, causing increased source-to-drain and drain-to-source current for transistors 204, 208, respectively, which results in the pole p1 changing with IL. In some cases, the size of transistor 502 may be proportional to the size of transistor 210 (according to a transistor size ratio) such that the current from transistor 502 is a fraction of IL. The gate voltage of transistor 506 is proportional to the current from transistor 502. The fixed current sunk via transistor 508 may be set (e.g., by setting the size of transistor 508) such that the phase margin of the LDO regulator meets specifications at a minimum IL. With the circuit 550, the Cc may be completely removed, or a smaller Cc may be used, in some cases.

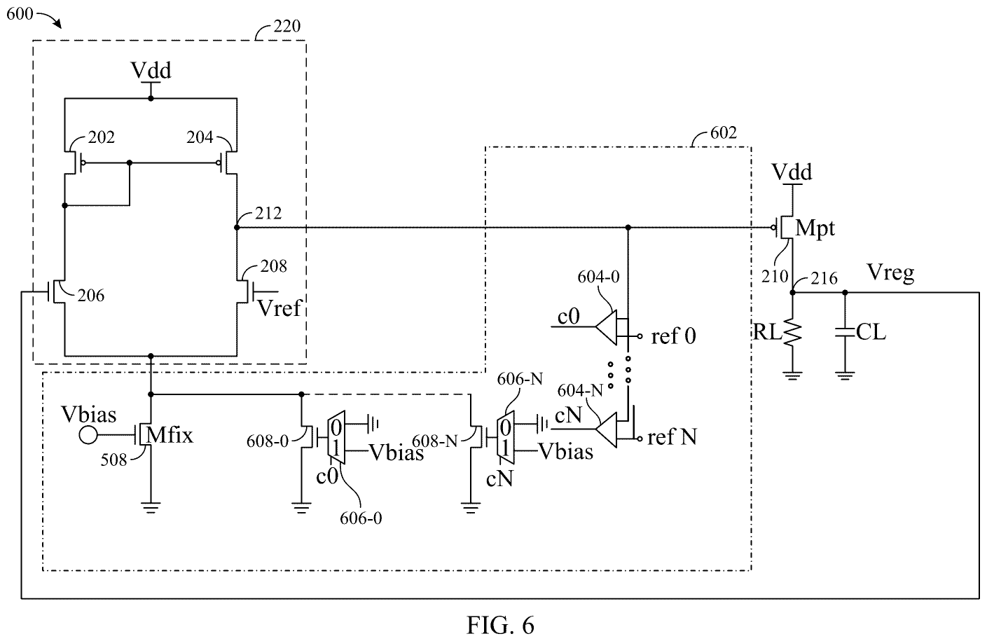

FIG. 6 illustrates an LDO regulator 600 implemented with a variable tail current source circuit 602 with digital circuitry, in accordance with certain aspects of the present disclosure. As shown, the circuit 602 may include comparators 604-0 to 604-N (collectively referred to as “comparators 604”), N being a positive integer. First inputs of comparators 604 may receive the gate voltage of transistor 210 that is a function of IL. Second inputs of the comparators 604 may receive respective reference voltages at respective nodes labeled ref0 to refN. The comparators 604 may generate control signals c0 to cN, respectively, that may be provided to control inputs and used to control respective multiplexers 606-0 to 606-N(collectively referred to as “multiplexers 606”). First inputs of the multiplexers 606 may be coupled to a reference potential node (e.g., electric ground) and second inputs of the multiplexers 606 may receive Vbias. Based on the control signals, each of the multiplexers 606 may couple a gate of a respective one of transistors 608-0 to 608-N(collectively referred to as “transistors 608”) to either electric ground or the Vbias node. As a result, one or more of transistors 608 may be controlled via a respective multiplexer to sink a current from the drains of transistors 206, 208. In other words, depending the gate voltage of transistor 210, one or more of comparators 604 may output a logic high to one or more respective multiplexers 606, such that the one or more multiplexers 606 control one or more of the respective transistors 608 to sink the current from the drains of transistors 206, 208.

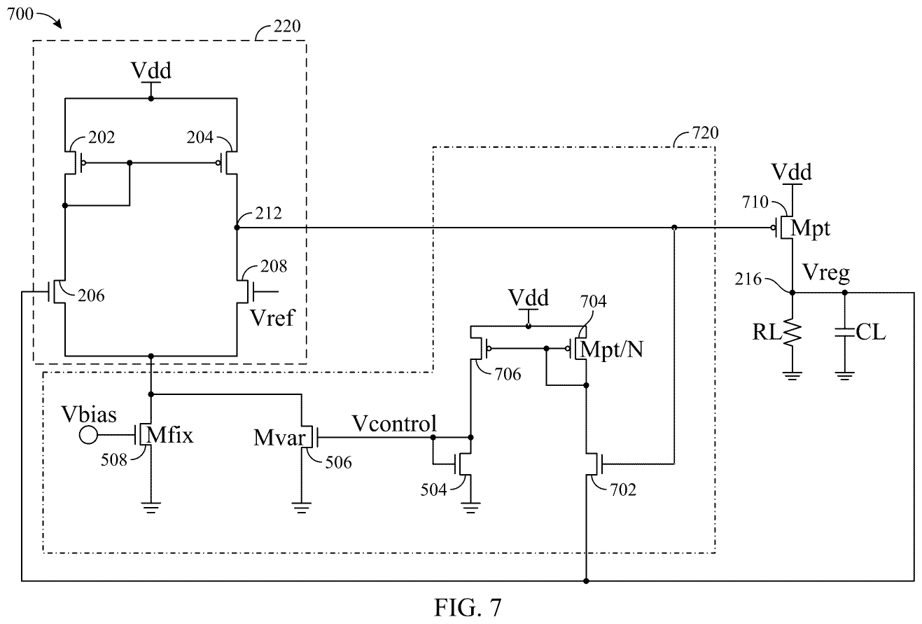

FIG. 7 illustrates an NMOS LDO regulator 700, in accordance with certain aspects of the present disclosure. As shown, the output 212 of the error amplifier 220 may be coupled to a gate of an NMOS transistor 710. The LDO regulator 700 may include a variable tail current source circuit 720 with an NMOS transistor 702. The gate of NMOS transistor 702 may be coupled to a gate of transistor 710. A source of transistor 710 may be coupled to the Vreg node and a drain of transistor 710 may be coupled to a drain of PMOS transistor 704. The transistor 704 may form a current mirror with the PMOS transistor 706. That is, transistor 704 may form one branch of the current mirror and the transistor 706 may form another branch of the current mirror. That is, the sources of transistors 704, 706 may be coupled to Vdd. A gate of transistor 704 may be coupled to a gate of transistor 706 and to the drain of transistor 704, as shown. The drain of transistor 706 may be coupled to the diode-connected transistor 504 to generate the gate voltage (Vcontrol) for transistor 506, as described herein. That is, based on the gate voltage of transistor 710 that is a function of IL, the gate of transistor 702 may be biased to sink a current from transistor 704. The current sunk from transistor 704 is mirrored to generate a current that is provided from transistor 706 to the diode-connected transistor 504. The mirrored current is converted to a voltage (Vcontrol) and provided to the gate of transistor 506 to generate a variable current sunk from the drains of transistors 206, 208.

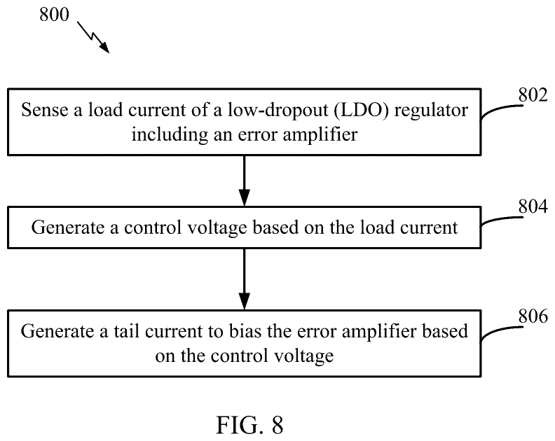

FIG. 8 is a flow diagram illustrating example operations 800 for voltage regulation, in accordance with certain aspects of the present disclosure. The operations 800 may be performed by an LDO regulator, such as the LDO regulator 500, 600, 700.

At block 802, the LDO regulator senses a load current (e.g., IL shown in FIG. 2) of the LDO regulator including an error amplifier (e.g., error amplifier 220). At block 804, the LDO regulator generates a control voltage (e.g., Vcontrol shown in FIG. 5 or Vbias provided by one or more of multiplexers 606) based on the load current. At block 806, the LDO regulator generates a tail current (e.g., Itail shown in FIG. 2) to bias the error amplifier based on the control voltage.

In some aspects, sensing the load current may include sensing a gate voltage (e.g., Vg shown in FIG. 5) of an output transistor (e.g., transistor 210, also referred to as a pass transistor) of the LDO regulator, the output transistor being coupled to an output (e.g., output 216) of the LDO regulator. In some aspects, generating the control voltage may include driving a gate of a first control transistor (e.g., transistor 502) of a control circuit (e.g., at least part of circuit 550) via the gate voltage to generate a current. Generating the control voltage may also include providing the current to a second control transistor (e.g., transistor 504) of the control circuit to generate the control voltage.

In some aspects, generating the control voltage may include comparing (e.g., via one or more of comparators 604 of FIG. 6) the gate voltage to a reference voltage to generate a compare signal (e.g., one or more of c0 to cN shown in FIG. 6). Generating the control voltage may also include controlling a multiplexer (e.g., one or more of multiplexers 606) based on the compare signal to generate the control voltage.

In some aspects, biasing the error amplifier may include controlling a frequency of a first pole (e.g., p1) at an output of the error amplifier to change proportional to the load current. A frequency of a second pole (e.g., p2) at the output of the LDO regulator may change, with respect to the load current, at a same rate as the frequency of the first pole with respect to the load current.

Some aspects of the present disclosure provide improved phase margin as described herein. Moreover, some aspects improve a power supply rejection ratio (PSRR) of the LDO regulator. For example, at a 10 mA load current (e.g., which may be typical for wireless local area network (WLAN) voltage-controlled oscillators (VCOs)), PSRR is improved as compared to LDO regulator implementations using Miller compensation.

### Example Aspects

Aspect 1: A low-dropout (LDO) regulator, comprising: an error amplifier; an output transistor coupled to an output of the LDO regulator and having a gate coupled to an output of the error amplifier; at least one first tail transistor coupled to the error amplifier; and a control circuit having an input coupled to the output transistor and at least one output coupled to at least one gate of the at least one first tail transistor.

Aspect 2: The LDO regulator of Aspect 1, wherein the input of the control circuit is coupled to a gate of the output transistor.

Aspect 3: The LDO regulator of Aspect 1 or 2, wherein: the error amplifier comprises: a first amplification transistor with a gate coupled to an output of the LDO regulator; and a second amplification transistor with a gate coupled to a reference voltage (Vref) node; and the at least one first tail transistor comprises at least one drain coupled to drains of the first amplification transistor and the second amplification transistor.

Aspect 4: The LDO regulator of Aspect 3, further comprising a second tail transistor comprising a gate coupled to a bias voltage (Vbias) node and a drain coupled to the drains of the first amplification transistor and the second amplification transistor.

Aspect 5: The LDO regulator according to any of Aspects 1-4, wherein the control circuit comprises: a first control transistor having a gate coupled to a gate of the output transistor and a source coupled to a voltage rail; and a second control transistor having a drain coupled to a drain of the first control transistor and to the at least one gate of the at least one first tail transistor.

Aspect 6: The LDO regulator of Aspect 5, wherein the output transistor has a first size, and wherein the first control transistor has a second size less than the first size.

Aspect 7: The LDO regulator of Aspect 5 or 6, wherein the second control transistor comprises a diode-connected transistor.

Aspect 8: The LDO regulator according to any of Aspects 1-7, wherein the control circuit comprises: a first control transistor having a gate coupled to a gate of the output transistor; a current mirror having a first branch coupled to a drain of the first control transistor; and a second control transistor having a drain coupled to a second branch of the current mirror and to a gate of the first tail transistor.

Aspect 9: The LDO regulator according to any of Aspects 1-8, wherein the control circuit comprises: one or more comparators, each of the one or more comparators including an input coupled to a gate of the output transistor; and one or more multiplexers, each of the one or more multiplexers including a control input coupled to an output of a respective one of the one or more comparators, at least one output of the one or more multiplexers being coupled to the at least one gate of the at least one first tail transistor, respectively.

Aspect 10: The LDO regulator according to any of Aspects 1-9, wherein the output transistor comprises a p-type metal-oxide-semiconductor (PMOS) transistor.

Aspect 11: The LDO regulator according to any of Aspects 1-10, wherein the control circuit is configured to control the at least one first tail transistor to generate a tail current to bias the error amplifier based on a load current of the LDO regulator.

Aspect 12: The LDO regulator of Aspect 11, wherein the control circuit and the at least one first tail transistor are configured to bias the error amplifier so that a frequency of a first pole at the output of the error amplifier changes proportional to the load current.

Aspect 13: The LDO regulator of Aspect 12, wherein a frequency of a second pole at the output of the LDO regulator is configured to change, with respect to the load current, at a same rate as the frequency of the first pole with respect to the load current.

Aspect 14: A method for voltage regulation, comprising: sensing a load current of a low-dropout (LDO) regulator including an error amplifier; generating a control voltage based on the load current; and generating a tail current to bias the error amplifier based on the control voltage.

Aspect 15: The method of Aspect 14, wherein sensing the load current comprises sensing a gate voltage of an output transistor of the LDO regulator, the output transistor being coupled to an output of the LDO regulator.

Aspect 16: The method of Aspect 15, wherein generating the control voltage comprises: driving a gate of a first control transistor of a control circuit via the gate voltage to generate a current; and providing the current to a second control transistor of the control circuit to generate the control voltage.

Aspect 17: The method of Aspect 15 or 16, wherein generating the control voltage comprising: comparing the gate voltage to a reference voltage to generate a compare signal; and controlling a multiplexer based on the compare signal to generate the control voltage.

Aspect 18: The method according to any of Aspects 14-17, wherein generating the tail current to bias the error amplifier comprises controlling a frequency of a first pole at an output of the error amplifier to change proportional to the load current.

Aspect 19: The method of Aspect 18, wherein a frequency of a second pole at the output of the LDO regulator changes, with respect to the load current, at a same rate as the frequency of the first pole with respect to the load current.

Aspect 20: An electronic device, comprising: one or more processors; and a power management integrated circuit coupled to the one or more processors and including a low-dropout (LDO) regulator, the LDO regulator comprising: an error amplifier; an output transistor coupled to an output of the LDO regulator and having a gate coupled to an output of the error amplifier; at least one tail transistor coupled to the error amplifier; and a control circuit having an input coupled to the output transistor and at least one output coupled to at least one gate of the at least one tail transistor.

### Additional Considerations

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes and variations may be made in the arrangement, operation, and details of the methods and apparatus described above without departing from the scope of the claims.

What is claimed is:

1. A low-dropout (LDO) regulator, comprising:
an error amplifier;
an output transistor coupled to an output of the LDO regulator and having a gate coupled to an output of the error amplifier;
at least one first tail transistor coupled to the error amplifier; and
a control circuit having an input coupled to the output transistor and at least one output coupled to at least one gate of the at least one first tail transistor.

2. The LDO regulator of claim 1, wherein the input of the control circuit is coupled to a gate of the output transistor.

3. The LDO regulator of claim 1, wherein:
the error amplifier comprises:
a first amplification transistor with a gate coupled to an output of the LDO regulator; and
a second amplification transistor with a gate coupled to a reference voltage (Vref) node; and
the at least one first tail transistor comprises at least one drain coupled to drains of the first amplification transistor and the second amplification transistor.

4. The LDO regulator of claim 3, further comprising a second tail transistor comprising a gate coupled to a bias voltage (Vbias) node and a drain coupled to the drains of the first amplification transistor and the second amplification transistor.

5. The LDO regulator of claim 1, wherein the control circuit comprises:
a first control transistor having a gate coupled to a gate of the output transistor and a source coupled to a voltage rail; and
a second control transistor having a drain coupled to a drain of the first control transistor and to the at least one gate of the at least one first tail transistor.

6. The LDO regulator of claim 5, wherein the output transistor has a first size, and wherein the first control transistor has a second size less than the first size.

7. The LDO regulator of claim 5, wherein the second control transistor comprises a diode-connected transistor.

8. The LDO regulator of claim 1, wherein the control circuit comprises:
a first control transistor having a gate coupled to a gate of the output transistor;
a current mirror having a first branch coupled to a drain of the first control transistor; and
a second control transistor having a drain coupled to a second branch of the current mirror and to a gate of the first tail transistor.

9. The LDO regulator of claim 1, wherein the control circuit comprises:
one or more comparators, each of the one or more comparators including an input coupled to a gate of the output transistor; and
one or more multiplexers, each of the one or more multiplexers including a control input coupled to an output of a respective one of the one or more comparators, at least one output of the one or more multiplexers being coupled to the at least one gate of the at least one first tail transistor, respectively.

10. The LDO regulator of claim 1, wherein the output transistor comprises a p-type metal-oxide-semiconductor (PMOS) transistor.

11. The LDO regulator of claim 1, wherein the control circuit is configured to control the at least one first tail transistor to generate a tail current to bias the error amplifier based on a load current of the LDO regulator.

12. The LDO regulator of claim 11, wherein the control circuit and the at least one first tail transistor are configured to bias the error amplifier so that a frequency of a first pole at the output of the error amplifier changes proportional to the load current.

13. The LDO regulator of claim 12, wherein a frequency of a second pole at the output of the LDO regulator is configured to change, with respect to the load current, at a same rate as the frequency of the first pole with respect to the load current.

14. A method for voltage regulation, comprising:
sensing a load current of a low-dropout (LDO) regulator including an error amplifier;
generating a control voltage based on the load current; and
generating a tail current to bias the error amplifier based on the control voltage.

15. The method of claim 14, wherein sensing the load current comprises sensing a gate voltage of an output transistor of the LDO regulator, the output transistor being coupled to an output of the LDO regulator.

16. The method of claim 15, wherein generating the control voltage comprises:
driving a gate of a first control transistor of a control circuit via the gate voltage to generate a current; and
providing the current to a second control transistor of the control circuit to generate the control voltage.

17. The method of claim 15, wherein generating the control voltage comprising:
comparing the gate voltage to a reference voltage to generate a compare signal; and
controlling a multiplexer based on the compare signal to generate the control voltage.

18. The method of claim 14, wherein generating the tail current to bias the error amplifier comprises controlling a frequency of a first pole at an output of the error amplifier to change proportional to the load current.

19. The method of claim 18, wherein a frequency of a second pole at the output of the LDO regulator changes, with respect to the load current, at a same rate as the frequency of the first pole with respect to the load current.

20. An electronic device, comprising:
one or more processors; and
a power management integrated circuit coupled to the one or more processors and including a low-dropout (LDO) regulator, the LDO regulator comprising:
an error amplifier;
an output transistor coupled to an output of the LDO regulator and having a gate coupled to an output of the error amplifier;
at least one tail transistor coupled to the error amplifier; and
a control circuit having an input coupled to the output transistor and at least one output coupled to at least one gate of the at least one tail transistor.
